(19) United States
(12) Patent Application Publication
(10) Pub. No.: US 2010/0153273 A1
(43) Pub. Date: Jun. 17, 2010

(54) SYSTEMS FOR PERFORMING TRANSACTIONS AT A POINT-OF-SALE TERMINAL USING MUTATING IDENTIFIERS

(75) Inventors: William R. Sellars, Milwaukee, WI (US); Richard Malina, Mequon, WI (US); William Cochran, Champaign, IL (US)

Correspondence Address: MICHAEL BEST & FRIEDRICH LLP, 100 E WISCONSIN AVENUE, Suite 3300, MILWAUKEE, WI, 53202, US

(73) Assignee: IMAGINEER SOFTWARE, INC., Milwaukee, WI (US)

(21) Appl. No.: 12/296,144

(22) PCT Filed: Feb. 8, 2007
(86) PCT No.: PCT/US2007/003410

§ 371 Date: Mar. 1, 2010

Related U.S. Application Data
(60) Provisional application No. 60/771,366, filed on Feb. 8, 2006.
(60) Provisional application No. 60/771,398, filed on Feb. 8, 2006.

(51) Int. Cl. H04L 9/32; G06Q 20/00

(52) U.S. Cl. 705/67; 705/71

(57) ABSTRACT

A point-of-sale (POS) terminal for use in performing a transaction between a first entity and a second entity at a POS, the POS terminal associated with the second entity. The POS terminal stores a second mutating identified, receives encrypted transaction information from an account information carrier device over a communication link, sending the encrypted first and second transaction information to an authenticator, and receiving the second mutating identifier from the authenticator and a processor configured to encrypt transaction information with the second mutating identifier to create second encrypted transaction information.

### RELATED APPLICATIONS

The present application claims priority to U.S. Provisional Application Nos. 60/771,366 and 60/771,398, both filed on Feb. 8, 2006, the entire contents of which are both herein incorporated by reference. The present application is also a continuation-in-part of U.S. application Ser. No. 11/368,959, filed on Mar. 6, 2006, which is a continuation-in-part of U.S. application Ser. No. 11/286,890, filed on Nov. 23, 2005, which is a continuation-in-part of U.S. application Ser. No. 10/854,604, filed on May 26, 2004, which is a continuation-in-part of U.S. application Ser. No. 10/248,894, filed on Feb. 27, 2003, which claims priority to U.S. Provisional Application No. 60/360,023, filed on Feb. 27, 2002, the entire contents of which are all herein incorporated by reference.

### BACKGROUND OF THE INVENTION

With increased use of credit cards, debit cards, and other non-cash forms of payment, account information used to access payment accounts must be securely transmitted between entities involved in a transaction. Traditionally, account information is obtained by a vendor point-of-sale (“POS”) terminal and is transmitted over a secure communication link between the vendor and a payment authenticator.

However, in the above protocol, account information is provided to the vendor as plaintext, and, if the account information is somehow obtained by an eavesdropper over the secure communication link, the eavesdropper can use the account information to initiate false transactions.

### SUMMARY OF THE INVENTION

Embodiments of the invention provide methods and systems for conducting a transaction at a vendor POS device using mutating identifiers (“IDs”). In particular, embodiments of the invention provide methods and systems for encrypting account information with a one-time-use mutating ID using an account information carrier (“AIC”) device associated with a buyer, such as a cellular phone, a personal digital assistant, an audio player (e.g., a Moving Pictures Experts Group Layer-3 Audio (“MP3”) player), etc. The AIC device stores account information for one or more accounts of a buyer and a one-time mutating ID assigned by a trusted authenticator. When the buyer initiates a transaction, the AIC device encrypts account information with the one-time-use mutating ID and transmits the encrypted account information to the vendor POS terminal. The vendor POS terminal forwards the encrypted account information and transaction information (e.g., the price of the transaction and an identifier of the vendor) to an authenticator for verification and/or payment authorization and completion. In some embodiments, the AIC device also obtains one-time-use account information from an authenticator (e.g., a payment authenticator that manages an account of the user of the AIC device) that can only be used for a single transaction and thereafter cannot be used again.

Some embodiments of the invention provide methods of performing a transaction between a first entity and a second entity at a physical location of a point-of-sale terminal that is associated with the second entity. One method includes encrypting buyer transaction information with a first mutating identifier stored in an account information carrier device associated with the first entity to create encrypted buyer transaction information, transmitting the encrypted buyer transaction information to an authenticator via at least one communication link, encrypting vendor transaction information with a second mutating identifier stored in the point-of-sale terminal to create encrypted vendor transaction information, transmitting the encrypted vendor transaction information to the authenticator from the point-of-sale terminal via at least one communication link, receiving a third mutating identifier from the authenticator at the account information carrier device, receiving a fourth mutating identifier from the authenticator at the point-of-sale terminal, and marking, at the authenticator, the first mutating identifier and the second mutating identifier as used.

Other embodiments of the invention provide methods of managing a transaction between a first entity and a second entity at a physical location of a point-of-sale terminal of the second entity by an authenticator. One method includes providing a first mutating identifier to an account information carrier device associated with the first entity over at least one communication link; providing a second mutating identifier to the point-of-sale terminal over at least one communication link; and receiving encrypted transaction information from at least one of the account information carrier device and the point-of-sale terminal over at least one communication link. The transaction information is encrypted with at least one of the first mutating identifier and the second mutating identifier. The method also includes decrypting the encrypted transaction information with at least one of the first mutating identifier and the second mutating identifier to obtain decrypted transaction information; generating a payment request based on the decrypted transaction information; transmitting the payment request to a payment authenticator over at least one communication link; and marking the first mutating identifier and the second mutating identifier as used.

Additional embodiments provide systems for managing a transaction between a first entity and a second entity at a point-of-sale terminal. One system includes an authenticator, an account information carrier device associated with the first entity, and the point-of-sale terminal associated with the second entity. The authenticator is configured to assign a first mutating identifier to the account information carrier device, to assign a second mutating identifier to the point-of-sale terminal, and to assign a third mutating identifier to a payment authenticator. The account information carrier device is configured to encrypt first transaction information with the first mutating identifier to create first encrypted transaction information and to transmit the first encrypted transaction information to the authenticator over at least one communication link. The point-of-sale terminal is configured to encrypt second transaction information with the second mutating identifier to create second encrypted transaction information and to transmit the first encrypted transaction information to the authenticator over at least one communication link. The authenticator is also configured to decrypt the first encrypted transaction information with the first mutating identifier to obtain the first transaction information, to decrypt the second encrypted transaction information with the second mutating identifier to obtain the second transaction information, to generate a payment request based on the first transaction information and the second transaction information, to encrypt the payment request with the third mutating identifier to create an encrypted payment request, to transmit the encrypted payment request to the payment authenticator over at least one communication link, and to mark the first mutating identifier and the second mutating identifier as used.

Further embodiments of the invention provide an account information carrier device for use in performing a transaction between a first entity and a second entity at a point-of-sale terminal associated with the second entity. One account information carrier device includes a memory module, an input/output module, and a processor. The memory module is configured to store a first mutating identifier. The input/output module is configured to send encrypted transaction information to the point-of-sale terminal over at least one communication link and to receive the first mutating identifier from an authenticator. The processor is configured to encrypt transaction information with the first mutating identifier to create the encrypted transaction information.

Embodiments of the invention also provide a point-of-sale terminal for use in performing a transaction between a first entity and a second entity at point-of-sale terminal, where the point-of-sale terminal is associated with the second entity. One point-of-sale terminal includes a memory module, an input/output module, and a processor. The memory module is configured to store a second mutating identifier. The input/output module is configured to receive encrypted first transaction information from an account information carrier device associated with the first entity over at least one communication link, to send the encrypted first transaction information and encrypted second transaction information to an authenticator over at least one communication link, and to receive the second mutating identifier from the authenticator. The processor is configured to encrypt transaction information with the second mutating identifier to create the encrypted second transaction information.

Other embodiments of the invention provide an authenticator for managing a transaction between a first entity and a second entity at a physical location of a point-of-sale terminal associated with the second entity. One authenticator includes a memory module, an input/output module, and a processor. The memory module is configured to store a first mutating identifier assigned to an account information carrier device associated with the first entity, to store a second mutating identifier assigned to the point-of-sale terminal, and to store a third mutating identifier assigned to a payment authenticator. The input/output module is configured to transmit the first mutating identifier to the account information carrier device over at least one communication link, to send the second mutating identifier to the point-of-sale terminal over at least one communication link, to send the third mutating identifier to the payment authenticator over at least one communication link, and to receive encrypted first transaction information and encrypted second transaction information from the point-of-sale terminal over at least one communication link. The processor is configured to decrypt the first encrypted transaction information with the first mutating identifier to obtain first transaction information, to decrypt the second encrypted transaction information with the second mutating identifier to obtain second transaction information, to generate a payment request based on the first transaction information and the second transaction information, to encrypt the payment request with the third mutating identifier to create an encrypted payment request, and to mark the first mutating identifier and the second mutating identifier as used. The input/output module can also be configured to transmit the encrypted payment request to the payment authenticator.

### BRIEF DESCRIPTION OF THE DRAWINGS

In the drawings:

FIG. 1 schematically illustrates a system for transmitting data within a network according to one embodiment of the invention.

FIG. 2 illustrates a bit stream (called a “mutating ID”) according to one embodiment of the invention.

FIGS. 3A and 3B illustrate ways of distributing mutating IDs.

FIG. 4 is a schematic illustration of a system of one exemplary embodiment of the invention where four entities are involved in a communication to perform electronic commerce.

FIG. 5 is a schematic illustration of a protocol used in the system of FIG. 4 according to one embodiment of the invention.

FIG. 6 depicts an exemplary point-of-sale terminal and two exemplary account information carrier devices: a cell phone, a smart card, and a credit card.

FIG. 7 is a schematic illustration of a system of one exemplary embodiment of the invention where four entities are involved in a communication to perform a transaction at a point-of-sale terminal.

FIG. 8 is a schematic illustration of the apparatus included in the system of FIG. 7 according to one embodiment of the invention.

FIG. 9 is a schematic illustration of a communication protocol used in the system of FIG. 7 according to one embodiment of the invention.

### DETAILED DESCRIPTION

Before embodiments of the invention are explained in detail, it is to be understood that the invention is not limited in its application, to the details of the construction and the arrangements of the components set forth in the following description or illustrated in the drawings. The invention is capable of still other embodiments and of being practiced or being carried out in various ways.

In particular, it should be understood that some embodiments are implemented using various computer devices, such as personal or home computers, servers, and other devices that have processors or that are capable of executing programs or sets of instructions, including special-purpose devices, such as set top boxes (e.g., digital cable or satellite decoders). In general, some embodiments may be implemented using existing hardware or hardware that could be readily created by those of ordinary skill in the art. Thus, the architecture of exemplary devices will not be explained in detail, except to note that the devices will generally have a processor, memory (of some kind), and input and output mechanisms. In some cases, the devices may also have one or more operating systems and one or more application programs that are managed by the operating systems. In some embodiments, the hardware devices or software executed by the hardware devices also provides some ability, depending on the role of the device in the particular embodiment of the invention implemented, to compress or decompress data or to encode data or decode encrypted data. In some instances, a decompression capability may be provided using available codecs, such as hardware-implemented Moving Picture Experts Group (“MPEG”) codecs. A decryption capability may be provided using a decryption hardware or software module capable of decrypting data that is encrypted using a particular encryption algorithm. In some embodiments, the encryption algorithm includes the Rijndael algorithm, an example of which is available at http://www.esat.kuleuven.ac.be/˜rijmen/rijndael/rijndaelref.zip.

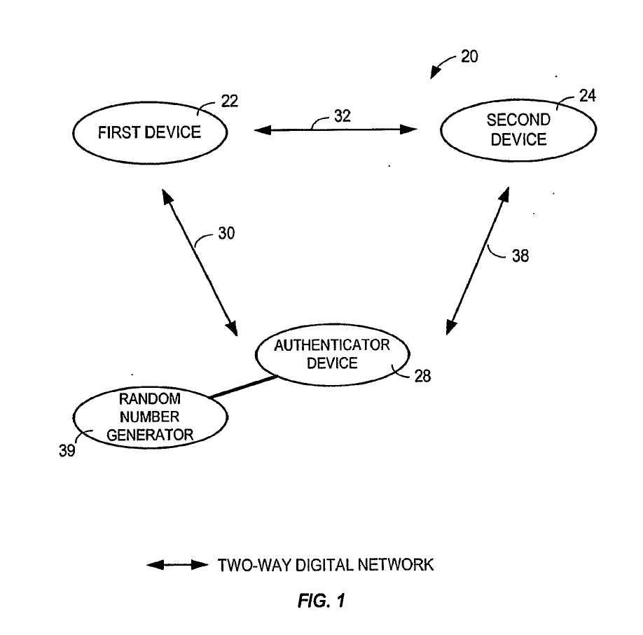

FIG. 1 illustrates an exemplary system 20 configured to distribute content over a network. In reality, one or more networks or communication systems, such as a private network (i.e., an intranet), the Internet, the telephone system, wireless networks, satellite networks, cable TV networks, and various other private and public networks and systems, could be used in various combinations to provide the communication links desired or needed to create embodiments or implementations of the invention, as would be apparent to one of ordinary skill in the art. Thus, the invention is not limited to any specific network or combinations of networks. However, in some embodiments, the networks or communication systems used in the system 20 have the ability to support digital and/or secure communications, such as communications involving data encrypted with a version of Rijndael encryption, secured socket layer (“SSL”) communications, digital signature standard (“DSS”) communications, or other types of secure communication protocols. Furthermore, data can be transferred from one entity to another with wired communications and/or wireless communications or other physical media being physically carried from one entity to another.

In the embodiment shown in FIG. 1, the system 20 includes three participants: a first device 22, a second device 24, and an authenticator device or authenticator 28. In the exemplary embodiment illustrated in FIG. 1, it is assumed that the first device 22 possesses data to be transmitted to the second device 24. Although FIG. 1 only illustrates the first device 22 and the second device 24, in some embodiments numerous devices are included in the system 20, wherein at least one of the devices possesses data to be transmitted to another device. Furthermore, in some embodiments, the system 20 includes multiple authenticators 28.

The first device 22, the second device 24, and the authenticator 28 are connected to each other via two-way links 30, 32, and 38. The links 30, 32, and 38 can include all or part of one or more of the networks mentioned above. In some embodiments, the system 20 uses a key-based encryption algorithm, such as the Rijndael algorithm. Choices for algorithms used in the system 20 can depend on a variety of factors including a trade off between the strength of the algorithm (in terms of being broken) and the speed of the algorithm (in terms of a processor's capability to perform the mathematical operations required by the chosen algorithm).

In some embodiments, as shown in FIG. 1, the authenticator 28 uses a random number generator 39 to generate numbers used by a protocol implemented or followed by the system 20. The random number generator 39 can produce numbers that are truly random (i.e., numbers that are as random as is possible with the particular technology used to implement the invention). For example, communication traffic, such as requests from customers to obtain content, can be used to create random numbers. Such requests occur, in general, in an unpredictable manner. Thus, the random numbers generated based on such traffic are also truly or nearly truly random, as opposed to pseudo random numbers generated with algorithmic methods.

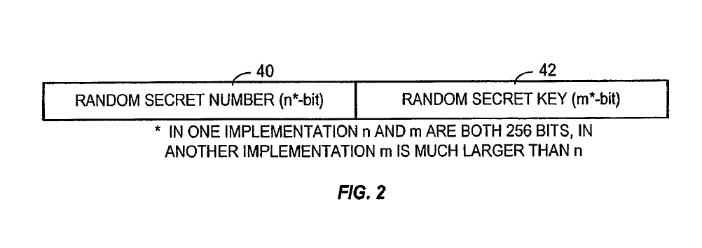

In some embodiments, the first device 22 and the second device 24 use mutating IDs to transmit data. An exemplary mutating ID 38 is shown in FIG. 2. The mutating ID 38 is an identifier having two portions: a first portion 40 and a second portion 42. The first portion 40 includes an identifying number, which is a random number. As indicated in FIG. 2, in some embodiments, the two portions of a mutating ID each include a predetermined number of bits. For example, the first portion 40 and the second portion 42 can each include 256 bits. In other embodiments, the first portion 40 and/or the second portion 42 include a larger number of bits, such as 1 megabit or 1 megabyte.

The second portion 42 of the mutating ID 38 includes a secret key, which is also a random number and, in some embodiments, is a symmetric cipher key. A mutating ID can be used only once and then cannot be used again.

In addition, although FIG. 2 illustrates a mutating ID has having only two portions, a mutating ID can include additional sections or portions. For example, a mutating ID can include an identifying number, a secret key for a first type of data (e.g., discoverable data), and a secret key for a second type of data (e.g., undiscoverable data).

Mutating IDs are generated and tracked by the authenticator 28. Because mutating IDs are one-time-use mechanisms, once the first device 22, the second device 24, or another device, uses its supply of mutating IDs (e.g., a single mutating ID or multiple mutating IDs), the device obtains another mutating ID (or multiple mutating IDs, if applicable) from the authenticator 28. The data included in a mutating ID assigned to a particular device can be chosen at random with an equal probability of all possible mutating IDs.

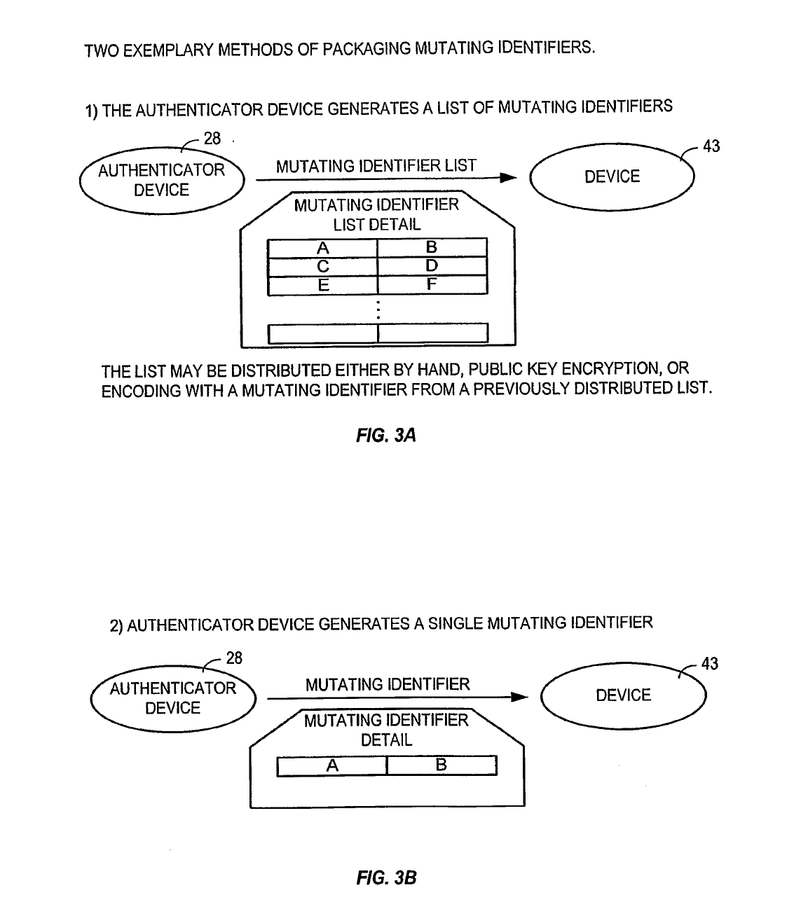

FIGS. 3a and 3b illustrate how mutating IDs can be distributed from the authenticator 28 to the first device 22 or the second device 24. As shown in FIG. 3a, in some embodiments, a device 43, such as the first device 22 or the second device 24, requests multiple mutating IDs from the authenticator 28. The authenticator 28 creates as many mutating IDs as the device 43 requested and sends a list of mutating IDs to the device 43. The device 43, knowing the quantity of mutating IDs requested and the size of each mutating ID, breaks the list into individual mutating IDs. In some embodiments, the authenticator 28 provides information or instructions to the device 43 to assist the device 43 in separating the list of mutating IDs into individual mutating IDs. For example, the authenticator 28 can provide information or instructions to the device 43 to assist the device 43 in separating the list of mutating IDs using a data description language, such as extensible markup language (“XML”).

As shown in FIG. 3b, in other embodiments, a device 43 can receive a single mutating ID from the authenticator 28. The device 43 can receive the single mutating ID upon requesting a mutating ID from the authenticator 28 or can automatically receive a new mutating ID from the authenticator 28 upon using a previously provided mutating ID. The mutating ID is sent to the device 43 and replaces the mutating ID previously provided or assigned to the device 43.

In the embodiment shown in FIG. 1, the authenticator 28 randomly assigns or provides a mutating ID to the first device 22 (hereinafter referred to in this example as the “first mutating ID”) and a mutating ID to the second device 24 (hereinafter referred to in this example as the “second mutating ID”). The first mutating ID is different from the second mutating ID and each of the first mutating ID and the second mutating ID do not provide information for determining the other mutating ID. As described above with respect to FIG. 2, each mutating ID includes a random number 40 and a corresponding random secret key 42. In some embodiments, a mutating ID takes the form of a modified hash. As described above, in addition to being random, the mutating ID (or the hash if applicable) is discarded after each use. In other words, the authenticator 28 provides a new mutating ID with a new random number 40 and a new random secret key 42 to a device after the device uses a mutating ID. In some embodiments, the mutating ID is completely unrelated from the device using it. That is, the mutating ID or the hash does not contain any information concerning the identity of the device receiving and using the mutating ID. In this way, except for the authenticator 28, individual devices can be blind to the identities of other devices included in the system.

Some embodiments of the invention implement symmetric key systems. Symmetric key systems commonly encounter key management issues as the number of entities or parties of the system grows. For example, a network of n entities requires n(n−1)/2 keys to enable all entities to communicate with one another. Thus, for a system of 1000 entities, where every entity wishes to send identical content to every other entity, almost a half million keys are required.

Disclosed embodiments, however, do not require a separate key for every pair of entities of the system. As will be illustrated, each entity and each piece of content distributed by each entity receives one key, which is mutated after each use. Therefore, for a system of 1000 entities, only 2000 keys are required compared to the almost half of a million keys with previous symmetric key systems. Also, the authenticator 28 is not required to store the entire bit string of a mutating ID. The authenticator 28 may use a hash function or simply a positional index to map each key partition of a mutating ID into a memory storage location based on the corresponding number of the mutating ID.

Other differences between embodiments of the invention and prior security systems relate to speed and reduced vulnerability to certain attacks. For example, the use of symmetric keys allows fast computation (as compared to public key systems). The fundamental concept behind public key systems is the use of one-way functions. One-way functions are easy to compute but hard to reverse. Public key systems use trapdoor one-way functions that provide a key to compute the one-way function in the opposite direction. Systems employing public key systems provide a public key and a private key for each participant. The public keys are accessible by all participants and the associated private keys are known only by the participant associated with the private key. Participants use the public keys to encrypt messages for a particular participant or to decrypt messages received from the particular participant using a one-way function. Participants use their confidential private key (which are believed to be computationally infeasible to derive from the public key) to encrypt messages for other participants (which the other participants can decrypt using the associated public key for the participant) or to decrypt messages received from other participants (which were encrypted with the associated public key for the participant).

The security of public key systems relies on the assumption that the private key cannot be derived from the public key. In order to maintain this requirement, the one-way functions used in public key systems are complex. The added complexity, however, comes at the cost of added computation time. Public key systems are often 1000 times slower than symmetric key systems.

The use of symmetric keys also reduces the effectiveness of chosen plaintext attacks. A chosen-plaintext attack occurs when an intruder has access to an encryption key or process, chooses specific plaintext to encrypt, and attempts to gain knowledge from the encrypted text. In public-key systems an individual's public key is known to all participants in a communication system. Any intruder can encrypt an endless number of messages using an individual's public key. If an attacker encrypts possible messages with an individual's public key and then intercepts an encrypted message sent to the individual, the intruder can compare the intercepted message with messages he or she has created. If an interception message matches an encrypted message created by the intruder, the message has been compromised and the intruder can now read a message that was not intended for him or her. This attack is relatively easy and effective if a small number of possible messages exist, but even if the number of possible messages is more than the intruder is able to encrypt or compare with intercepted encrypted messages, just knowing that an intercepted encrypted message does not correspond to a particular message can provide useful information to the intruder. In both situations, the intruder will not be able to deduce the private key of the individual, but the intruder may be able to deduce the message, or information regarding the message, sent to the individual. Since embodiments of the invention utilize a symmetric key system, chosen-plaintext attacks are not applicable because encryption keys are not public knowledge.

There is another problem with prior symmetric key systems and public key systems. Once an unauthorized entity gains access to a key, the unauthorized entity can decode all messages encrypted with the key, and, perhaps more dangerous, can encrypt false messages with the key in order to deceive other entities of the system. The mutating ID protocol reduces this weakness by mutating each secret key after it has been used. Even if a key is compromised, the compromised key cannot be used to generate future messages nor can it be used to decrypt future messages since it is marked by the authenticator 28 as “used” and, therefore, cannot and will not be used for future messages.

The authenticator 28 can also generate encryption keys for content or data distributed through the system 20. To request an encryption key, a device wanting to send data (i.e., the “sending device”) supplies the authenticator 28 with the data it wants to transmit or a label or function (i.e., any identifying string) of the data it wants to transmit, and the authenticator 28 responds with an associated encryption key. The encryption key, like the mutating IDs, can be unrelated to the data that it encrypts. In addition, if the sending device only sends an identifier to the authenticator 28 (e.g., a random identifier) of the data it wants to transmit, the authenticator 28 has no knowledge of the data associated with a particular encryption key. The authenticator 28 records the assigned key and the associated data or identifier of the data.

After the authenticator 28 generates and supplies an encryption key to the sending device, the sending device uses the encryption key to encrypt the data. The sending device then sends the encrypted data to a device. To decrypt the encrypted data, the device receiving the encrypted data (i.e., the “receiving device”) requests the corresponding decryption key (e.g., the same key used to encrypt the data) from the authenticator 28. In some embodiments, the authenticator 28 supplies a decryption key to any device included in the system 20 that makes a legitimate request. A request for a decryption key can include a reference to the data (e.g., the label or identifying string of the data) that the receiving device wants to decrypt. The authenticator 28 determines the associated decryption key based on the reference to the data indicated in the request and returns the appropriate decryption key to the receiving device.

Exemplary embodiments of the invention will now be described using several examples. As with many descriptions of communication protocols, names are assigned to the various devices (or computer systems associated with those devices) used in the protocol. In one embodiment, Alice (A) and Bob (B) represent the first device 22 and the second device 24, respectively, and Trent (T) represents the authenticator 28, a trusted arbiter of communication. Carol (C) can also represent a third device included in the system 20. The following table, Table 1, is a list of other symbols used in this document to explain multiple embodiments of the proposed protocol.

TABLE 1

| Symbol | Meaning |
|---|---|
| A, B, C, T, V | Entities (e.g., devices) included in the system. |
| S | A document (e.g., a bill of sale). |
| P | Data (e.g., a message, a price, a piece of information of a |
| | document, etc.). |
| X | Secret information (e.g., an account number). |
| Account_{X} | Account information for entity X. |
| X_{id} | An identifier (e.g., public identifier) for an entity X. |
| X_{cred} | Secret information that identifies an entity X, which is |
| | known only to the entity X and the authenticator and is |
| | randomly assigned by the authenticator. |
| K_{X} | A key for a symmetric cipher associated with |
| | some entity X. |
| N_{X} | A one-use number associated with some key K_{X}. |
| H(X) | A function that produces a hash of X. |
| E(K, X) | A cipher that encrypts X with K. |
| X → Y:Z | A message Z sent from X to Y. |
| XOR(Y, Z) | Bitwise exclusive or of Y and Z |

### Session Keys

In some embodiments, mutating IDs are used to exchange a communication or session key between two entities. For example, assume that Alice and Bob would like to communicate securely using a session key shared by Alice and Bob. Again assume that Alice and Bob trust Trent and that Trent assigns Alice a mutating ID that includes a number N_{A} and a secret key K_{A} for some symmetric cipher and assigns Bob a mutating ID that includes a number N_{B} and a secret key K_{B} for some symmetric cipher. Also assume that Alice and Bob each have credentials (e.g., A_{cred} and B_{cred}, respectively) that are known only to Trent and the holder of the credentials.

To request a session key (e.g., K_{AB}) from Trent, Alice encrypts her credentials A_{cred} and an identifier of Bob (e.g., B_{id}) with her secret key K_{A} and appends her number N_{A} to the result. Alice sends the message to Bob.
A→B: N_{A}E(K_{A}, A_{cred} B_{id})

Bob concatenates his credentials B_{cred} and an identifier of Alice (e.g., A_{id}) with the message from Alice and encrypts the result with his secret key K_{B}. Bob appends his number K_{B} to the result of the encryption and sends the resulting message to Trent.
B→T: N_{B}E(K_{B}, B_{cred}A_{id}N_{A}E(K_{A}, A_{cred}B_{id})

Trent identifies that the message has come from Bob because Trent knows that the number N_{B} is associated with Bob. Trent decrypts the message using K_{B} (i.e., the assigned secret key associated with the number N_{B}) and verifies Bob's credentials B_{cred}. Trent also decrypts and verifies the part of the message constructed by Alice. If Bob's credentials B_{cred} match his number N_{B} and his identifier B_{id} provided by Alice and Alice's credentials A_{cred} match her number N_{A} and her identifier A_{id} provided by Bob, Trent verifies the request. After verifying the request, Trent generates a message for Alice and a message for Bob. The message for Alice includes a new number N_{A}′, a new secret key K_{A}′, Alice's credentials A_{cred}, and a session key K_{AB}. Trent encrypts the message for Alice with Alice's current secret key K_{A}. The message for Bob includes a new number N_{B}′, a new secret key K_{B}′, Bob's credentials B_{cred}, and a session key K_{AB}. Trent encrypts the message for Bob with Bob's current secret key K_{B}. Trent sends the messages to Alice and Bob.
T→A: E(K_{A}, N_{A}′ K_{A}′ A_{cred}K_{AB})
T→B: E(K_{B}, N_{B}′ K_{B}′ B_{cred}K_{AB})

The above protocol can be extended to include more entities. For example, if Alice wants a session key associated with Bob and Carol, Alice can list known identifiers of Bob and Carol, such as Bob's identifier B_{id} and an identifier of Carol (e.g., C_{id}) in her message. Similarly, Bob can list identifiers of Alice and Carol, and Carol can list identifiers of Alice and Bob. Each entity can also include their credentials in their message. As shown above, each entity can forward their message to another entity associated with the requested session key and each entity can add their message to the received message. Once all the intended entities have added their individual message to the request, the last entity forwards the request to Trent. Trent verifies that the credentials of each entity match the mutating IDs (e.g., the numbers of the mutating IDs) assigned to each entity and that the list of identifiers specified by each entity match the provided credentials. After verifying the request, Trent sends a new mutating ID (e.g., a new number and a new secret key) and the session key associated with the listed entities to each entity.

### Content Use Licenses

Mutating IDs can also be used to provide a license that an entity can use to obtain and decode a piece of content. For example, assume Alice has content or a message P that she wants to securely send to Bob. Again assume that Alice and Bob trust Trent and that Trent assigns Alice a mutating ID that includes a number N_{A} and a secret key K_{A} for some symmetric cipher and assigns Bob a mutating ID that includes a number N_{B} and a secret key K_{B} for some symmetric cipher. Also assume that Alice and Bob each have credentials (e.g., A_{cred} and B_{cred}, respectively) that are known only to Trent and the holder of the credentials.

To obtain a license for the message P, Alice generates a hash of the message P (e.g., H(P)), concatenates the message hash H(P) with her credentials A_{cred}, and encrypts the result with her secret key K_{A}. Alice also appends her number N_{A} to the encryption result. Alice sends the resulting license request to Trent.
A→T: N_{A}E(K_{A}, A_{cred} H(P))

Trent decrypts the license request from Alice and generates a response to Alice that includes a new mutating ID that includes a new number N_{A}′ and a new secret key K_{A}′ for Alice, a mutating ID to be associated with a license for the message P that includes a license number (e.g., N_{H(P)}) and a license secret key (e.g., K_{H(P)}), and an encryption key (e.g., K_{P}) for the message P. In some embodiments, Trent also includes the message hash H(P) in the response to Alice so that Alice can ensure that the message has not been tampered with (e.g., provided by an imposter). Trent encrypts the response with Alice's current secret key N_{A} and sends the encrypted response to Alice.
T→A: E(K_{A}, N_{A}′ K_{A}′ N_{H(P)} K_{H(P)} K_{P} H(P))

Once Alice obtains the response from Trent, Alice decrypts the response and obtains the key K_{P} and the mutating ID associated with a license for the message P. Alice encrypts the message P with the key K_{P} and generates a license for the encrypted message P. The license for the encrypted message P includes Alice's credentials A_{cred} and the message hash H(P). In some embodiments, the license also includes an identifier of the recipient of the license. For example, if Alice is going to send the license to Bob, the license can include an identifier of Bob (e.g., B_{id}). In some embodiments, an identifier of the recipient is excluded from the license in order to reduce the complexity of the protocol. For example, digital media production companies may not know ahead of time or track potential recipients of content.

Alice encrypts the license with the license secret key K_{H(P)} and appends the associated license number N_{H(P)} to the encryption result. Alice sends the encrypted message P and the associated license to Bob.
A→B: E(K_{P}, P)
A→B: N_{H(P)}E(K_{H(P)}, A_{cred}H(P) B_{id})

At some point after receiving the encrypted message P and the associated license, Bob requests the decryption key for the encrypted message P. To generate a request for the decryption key, Bob concatenates his credentials B_{cred} to the license Alice provided and encrypts the result with his secret key K_{B}. Bob also appends his number N_{B} to the encrypted concatenation and sends the resulting request to Trent.
B→T: N_{B}E(K_{B},B_{cred} N_{H(P)}E(K_{H(P)}, A_{cred}H(P) B_{id}))

Trent unrolls the encryption, and, if an identifier of Bob is included in the license, Trent verifies that the credentials B_{cred} and the number N_{B} provided in the request match the identifier in the license Alice generated. Trent also verifies that the message hash H(P) included in the request matches the license number N_{H(P)} and the license secret key K_{H(P)}. After verifying the message from Bob, Trent sends Bob a decryption (e.g., K_{P}) that can be used to decrypt the encrypted message P, a mutating ID that includes a new number N_{B}′ and a new secret key K_{B}′ for Bob, and Bob's credentials B_{cred} all encrypted with Bob's current secret key K_{B}.
T→B: E(K_{B}, N_{B}′ K_{B}′ K_{P} B_{cred})

Optionally, Trent can also inform Alice that Bob requested the decryption key.
T→A: E(K_{A}′, “Bob requested the key associated with the identifier H(P)”)

After providing the decryption key to Bob, the license Alice provided to Bob is no longer valid because Trent has already seen the license number N_{H(P)} and the license secret key K_{H(P)} associated with the one-time-use mutating ID associated with the license for the message P.

As in the previous example, this protocol can be extended to include multiple entities by having each entity add their credentials to the license, encrypt the result with their assigned mutating ID, and forward the modified license to the next entity. For example, if Alice generates and sends a license to Carol who forwards the license to David who then sends the license to Bob, the resulting license received by Trent would be as follows:
T→A: N_{B}E(K_{B}, B_{cred} N_{D}E(K_{D}, D_{cred} N_{C}E(K_{C}, C_{cred} N_{H(P)}E(K_{H(P)}, A_{cred} H(P) B_{id})))

### Digital Signatures

So far we have discussed the use of mutating IDs to establish a session key for secure communication and to deliver encrypted data and a corresponding license. In another embodiment, mutating IDs are used as digital signatures. Assume that Alice and Bob each have a copy of a document S that includes a piece of information P that requires an agreement between Alice and Bob. For example, the document S can include a bill of sale and the piece of information P requiring an agreement between Alice and Bob can include the final price for the bill of sale. Also assume that Carol is an arbiter of agreements (e.g., a credit card company or a bank) who may need to know the piece of information P but not necessarily the document S. Again assume that Alice, Bob, and Carol each trust Trent and that Trent assigns Alice a mutating ID that includes a number N_{A} and a secret key K_{A} for some symmetric cipher, assigns Bob a mutating ID that includes a number N_{B} and a secret key K_{B} for some symmetric cipher, and assigns Carol a mutating ID that includes a number N_{C} and a secret key K_{C} for some symmetric cipher. Also assume that Alice, Bob, and Carol each have credentials (e.g., A_{cred}, B_{cred}, and C_{cred}, respectively) that are known only to Trent and the holder of the credentials.

To initiate the signing of the document S, Alice generates a message that includes the document S or a hash of the document S (e.g., H(S)) and a hash of her credentials (e.g., H(A_{cred})). In some embodiments, Alice disguises or encodes the message. For example, Alice can generate an XOR of the document hash H(S) and the credentials hash H(A_{cred}). The message can also include the piece of information P. Alice encrypts the message with her secret key K_{A}, appends her number N_{A} to the result, and sends the resulting message to Bob.
A→B: N_{A}E(K_{A}, XOR(H(S), H(A_{cred}))P)

Bob generates a similar message that includes an XOR of the document hash H(S) and a hash of his credentials (e.g., H(B_{cred})). In some embodiments, Bob also adds the piece of information P to the message. Bob adds his message to the message received from Alice and encrypts the result with his secret key K_{B}. Bob appends his number N_{B} to the resulting message and sends the result to Trent.
B→T: N_{B}E(K_{B}, XOR(H(S), H(B_{cred}))P N_{A}E(K_{A}, XOR(H(S), H(A_{cred}))P))

Trent decrypts the message from Bob and verifies that the document hashes H(S) generated by Alice and Bob are equivalent. If Alice and Bob included the piece of information P in their messages, Trent also verifies that the pieces of information P provided from Alice and Bob are equivalent. After verifying the message, Trent generates receipts for Alice and Bob. Alice's receipt includes an identifier of Bob (e.g., B_{id}), the document hash H(S), and, optionally, the piece of information P. Trent encrypts Alice's receipt with a receipt secret key K_{receipt} that is part of a mutating ID associated with the receipts for Alice and Bob but that is known only to Trent. Trent also appends an associated receipt number N_{receipt} included in the mutating ID associated with the receipts for Alice and Bob to Alice's receipt. Trent then encrypts Alice's receipt, a new mutating ID for Alice that includes a new number N_{A}′ and a new secret key K_{A}′, and Alice's credentials A_{cred} with Alice's current secret key K_{A} and sends the result to Alice.
T→A: E(K_{A}, N_{A}′ K_{A}′ A_{cred}N_{receipt}E(K_{receipt}, B_{id} H(S) P))

Trent generates a similar receipt for Bob that includes an identifier of Alice (e.g., A_{id}), the document hash H(S), and, optionally, the piece of information P. Trent encrypts Bob's receipt with the same receipt key K_{receipt} as he encrypted Alice's receipt and appends the same receipt number N_{receipt} as he appended to Alice's receipt. Trent encrypts Bob's receipt, a new mutating ID for Bob that includes a new number N_{B}′ and a new secret key K_{B}′, and Bob's credentials B_{cred} with Bob's current secret key K_{B} and sends the result to Bob.
T→B: E(K_{B}, N_{B}′ K_{B}′ B_{cred} N_{receipt} E(K_{receipt}, A_{id} H(S) P))

By encrypting the receipts for Alice and Bob with a key known only to Trent, Alice and Bob cannot tamper with the receipt. To have their receipt verified by the arbitrator, Alice and Bob present their receipts to Carol, and Carol forwards one or both of the receipts to Trent for verification. For example, assume that Alice provides her receipt to Carol. Carol adds her credentials to Alice's receipt and encrypts the result with her secret key K_{C}. Carol appends her number N_{C} to the result and sends the message to Trent.
C→T: N_{C}E(K_{C}, C_{cred} N_{receipt} E(K_{receipt}, B_{id} H(S) P))

Trent decrypts the message from Carol and verifies Alice's receipt by decrypting the receipt (i.e., since Trent and only Trent knows K_{receipt}) and providing Carol with the receipt details. For example, Trent can generate a message for Carol that includes a new mutating ID for Carol that includes a new number N_{C}′ and a new secret key K_{C}′, Carol's credentials C_{cred}, the identifier of Alice A_{id}, the identifier of Bob B_{id}, the document hash H(S), and, optionally, the piece of information P. Trent encrypts the message with Carol's current secret key K_{C} and sends the result to Carol.
T→C: E(K_{C}, N_{C}′ K_{C}′ C_{cred} A_{id} B_{id} H(S) P)

Carol uses the information from Trent to arbitrate the agreement between Alice and Bob. For example, Carol can use the information from Trent to verify that Alice and Bob have agreed to the piece of information P included in the document S.

It should be understood that the above protocol can be expanded to include other numbers of entities.

### Black Protocol

The secret keys of mutating IDs (e.g., K_{A}, K_{B}, and K_{C} need to remain secret in order to protect the security of transmitted data encrypted with the secret keys. For example, if Trent provides Alice with a new mutating ID encrypted with Alice's current secret key (e.g., K_{A}), an eavesdropper who has determined Alice's current secret key can obtain Alice's new mutating ID. The eavesdropper can then use the new mutating ID to send false data and/or to obtain the plaintext of future data exchanged between Alice and Trent.

Eavesdroppers can determine (or attempt to determine) a key used to encrypt particular data by performing an attack. For example, an eavesdropper can perform a brute force attack. A brute force attack includes decrypting ciphertext with every possible key until a key is found that produces coherent or recognizable data (e.g., human readable data). If the eavesdropper obtains or knows the plaintext (or a portion or pattern thereof) corresponding to obtained ciphertext, the eavesdropper can more easily determine whether a correct candidate key has been found. For example, if the eavesdropper obtains ciphertext and knows that the ciphertext includes an individual's name followed by a 4-digit personal identification number (“PIN”), the eavesdropper can apply candidate keys until a candidate key produces the plaintext including the individual's name. The eavesdropper can then assume, with some certainty, that the remaining information included in the generated plaintext corresponds to the PIN.

However, if the eavesdropper has no knowledge of the plaintext or a pattern of the plaintext (i.e., has no content hint), the eavesdropper's ability to determine whether a correct candidate key has been found is greatly reduced and, perhaps, eliminated. For example, if plaintext includes a random number encrypted with a particular key, no matter how many keys the eavesdropper attempts in a brute force attack, the eavesdropper will have no way to determine whether candidate plaintext is the true plaintext corresponding to the ciphertext. Decrypting an encrypted random number with any candidate key will produce a random number that is equally likely to be the original random number as every other random number produced by every other candidate key.

Referring to the session key example described above involving Alice, Bob, and Trent, if any portion of an encrypted message is recognizable, known, becomes known, or includes any content hints, an eavesdropper could possibly perform a plaintext or partial-plaintext attack on the encrypted message and uncover a secret key of Alice or Bob used to encrypt the message. For example, assume that Alice sends the following message to Bob that is intercepted by an eavesdropper.
A→B: N_{A}E(K_{A}, A_{cred} B_{id})

The eavesdropper can perform a brute force attack on the intercepted message because Bob's identifier B_{id} and the format of the above message are known or public. Thus, the eavesdropper can obtain Alice's secret key K_{A} and her credentials A_{cred}. Furthermore, once the eavesdropper obtains Alice's current secret key K_{A}, the eavesdropper can use Alice's current secret key K_{A} to obtain all data encrypted with Alice's current secret key K_{A}, such as her next mutating ID (e.g., N_{A}′ and K_{A}′).

An eavesdropper can use other knowledge about an encrypted message or the communication protocol used to generate an encrypted message to perform brute force attacks. For example, an eavesdropper can use the mutating ID number (e.g., N_{A}), which is passed in the clear, to perform a brute force attack. An eavesdropper could also use knowledge of the algorithm used to generate the mutating ID numbers to perform a brute force attack.

As pointed out above, keys used to encrypt undiscoverable data (i.e., data that is random or has no content hints) cannot be easily determined or discovered using a brute force attack, since an eavesdropper will be unable to determine when a correct candidate key is found. Keys used to encrypt discoverable data (i.e., data that is known, may be later disclosed, is recognizable, or has a known or easily guessed format), however, can (theoretically) be determined using a brute force attack. When the discoverable data and the undiscoverable data are encrypted together or with the same encryption key (e.g., a recognizable name and a corresponding possibly random PIN encrypted with the same key), a key determined through a brute force attack using the discoverable data is also the key used to encrypt the undiscoverable data and, therefore, the undiscoverable data can be discovered.

To increase the security of the undiscoverable or secret data, separate keys can be used to encrypt the different types of data (hereinafter referred to as “separate encryption protocols”). For example, one or more keys (e.g., one or more mutating IDs) can be used to encrypt the undiscoverable data (e.g., the secret keys K_{A}, K_{B}, and K_{C} and one or more keys (e.g., one or more mutating IDs) can be used to encrypt the discoverable data (e.g., B_{id}). Since the same keys are never used to encrypt undiscoverable data and discoverable data, the possibility of an eavesdropper determining undiscoverable date is reduced.

### Electronic Commerce

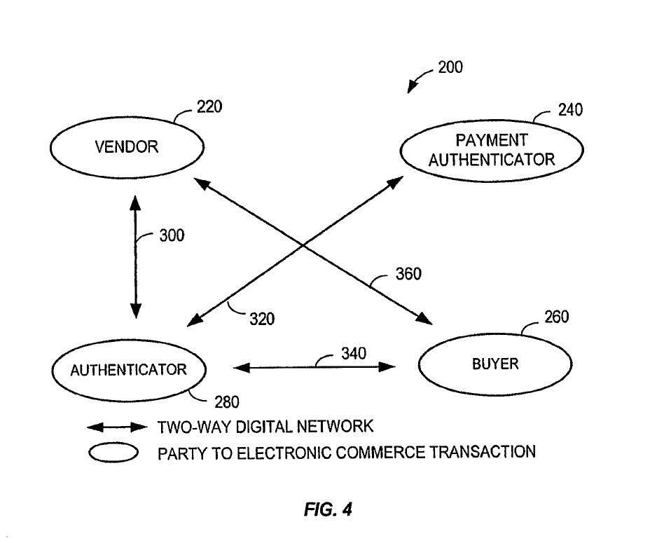

Mutating IDs can also be used in electronic commerce protocols. FIG. 4 illustrates an exemplary system 200 configured to perform electronic commerce. In the embodiment shown in FIG. 4, the system 200 includes four participants: a vendor 220; a payment authenticator device or payment authenticator 240, such as a credit card company, a financial institution, or the like; a buyer 260; and an authenticator 280. Although only one vendor 220, payment authenticator 240, and buyer 260 are shown, in most implementations, numerous vendors, payment authenticators, and buyers will be involved. Further, there could be multiple authenticators 280, although only one is required. In practice, it is likely that the following relationship will exist: number of authenticators<number of payment authenticators<number of vendors<number of buyers, but again there is no limit on the number of participants or any requirement of a particular relationship between the numbers of the various types of participants.

In some embodiments, the vendor 220, the payment authenticator 240, and the buyer 260 are connected to the authenticator 280 via two-way links 300, 320, and 340. The vendor 220 and the buyer 260 are also connected via a two-way link 360. These links may be constructed from all or part of the networks mentioned above. In some embodiments, the link 360 includes a non-secure hypertext transport protocol (“HTTP”) link. As described above for system 20, the system 200 can use a key-based encryption algorithm, such as the Rijndael algorithm.

The vendor 220 is an entity, such as a retail company, that wishes to sell its goods and/or services electronically. It is assumed that the vendor 220 wants to be reimbursed fairly for goods and/or services, both referred to as goods hereafter, exchanged using the system 20. Thus, in one embodiment of the invention, the system 200 is configured such that the vendor 220 can produce a bill of sale for goods and/or services sold to a buyer. The bill of sale can include a transaction identifier. In some embodiments, the transaction identifier includes a vendor identifier.

Buyers 260 and vendors 220 agree on a bill of sale and an associated price. The buyer 260 can authorize the financing of a transaction for items listed in the bill of sale at the agreed upon price from an account managed by a payment authenticator 240. After a transaction is completed, buyers 260, vendors 220, and payment authenticators 240 can receive an unforgeable receipt of the transaction from the authenticator 280 as described above with respect to the digital signature example.

It is assumed that at least some buyers 260 may wish or attempt to purchase goods electronically without paying for them or with funds from an account that the buyer 260 is not authorized to manage. It is also assumed that a buyer 260 requires a secure transaction where payment information (e.g., account numbers) cannot be compromised. Therefore, embodiments of the invention provide measures to prevent unauthorized purchasing of goods and to provide a secure transaction through the use of mutating IDs.

The payment authenticator 240 is an entity, such as a credit card company or financial institution, that manages accounts that can be used to finance transactions (in terms of money or other payment forms or mechanisms). The payment authenticator 240 can agree to finance an electronic transaction from a particular account upon receiving a valid request including an identifier of the account, and, therefore, account identifiers are kept confidential between the payment authenticator and the account holder in order to ensure that requests can only be generated by the account holder. Thus, in some embodiments of the invention, the system 200 is configured such that the buyer 260 and the payment authenticator 240 agree on a secret account identifier for an account of the buyer 260 managed by the payment authenticator 240. Further, authorizations for payment of a transaction from an account are encrypted with a mutating ID in order to prevent a payment request from being tampered with, reused, etc.

The authenticator 280 holds the data necessary to perform secure electronic transactions. In some embodiments, the authenticator 280 verifies the vendor 220, the payment authenticator 240, and the buyer 260 based on their mutating IDs before allowing an e-commerce transaction to take place. The authenticator 280 can also verify the receipts of the buyer, the vendor, and the payment authenticator. In addition, the authenticator 280 can perform the above actions without knowing the buyer's account information or the details of the transactions. The authenticator 280 is also the source of mutating IDs and keeps track of such IDs using a database or similar mechanism. In some embodiments, the functionality of the authenticator 280 and the payment authenticator 240 can be combined and provided as a single entity.

Exemplary embodiments of the invention will now be described using several examples. One embodiment of the protocol involves four participants. The entity Bob (e.g., B) performs the role of the buyer 260, the entity Vera (e.g., V) performs the role of the vendor 220, the entity Carol (e.g., C) performs the role of the payment authenticator 240, and the entity Trent (e.g., T) performs the role of the authenticator 280. The protocol involves Bob purchasing goods from Vera. Bob purchases or pays for the goods using an account managed by Carol. Trent arbitrates communication between Bob, Vera, and Carol. Since the proposed protocol relies on a trusted authority, Bob, Vera, and Carol each trust Trent. Further, all mutating IDs used in the protocol are assigned and known by Trent. Each mutating ID is known only to Trent and the holder of the mutating ID. It is assumed that Bob, Vera, and Carol each hold mutating IDs or number/key pairs (e.g., (N_{B}, K_{B}), (N_{V}, K_{V}), and (N_{C}, K_{C}), respectively) issued from Trent.

For the purposes of this example only, assume Bob wishes to purchase goods from Vera. Bob and Vera agree on a bill of sale (e.g., S) and an associated price (e.g., P). Bob wishes to pay Vera the price P of the transaction with funds drawn from an account Carol manages on behalf of Bob. The account is identified by credentials (e.g., B_{cred}). The credentials B_{cred} are a secret known or recognizable only to Bob, Carol, and Trent. In some embodiments, as described below, the credentials B_{cred} represent an account number assigned by Carol for Bob's account. In other embodiments, the credentials B_{cred} are assigned by Trent. If the credentials B_{cred} are known to Trent and Carol, both Trent and Carol can use the credentials B_{cred} to verify that Bob created a particular message. Carol may also use Bob's credentials B_{cred} to verify Bob's account number.

It should be noted that Trent does not have to “know” the credentials of buyer a priori or before hand for the protocol to work. In some embodiments, Trent only forwards the credentials to Carol for verification and use. Furthermore, in some embodiments, Trent cannot obtain data, such as an account number, included or represented in credentials received from a particular buyer. For example, if Carol provides Bob with credentials B_{cred} that are based on confidential data known only to Bob and Carol (e.g., Bob's account number, expiration date, social security number, etc.), although Trent receives the credentials B_{cred} from Bob, Trent cannot determine any of Bob's confidential data. This can help increase the security of the protocol.

For example, the credentials B_{cred} are constructed from a secret known only to Bob and Carol (e.g., Bob's account number). The credentials B_{cred} can also be constructed from details regarding the current transaction. In some embodiments, the credentials B_{cred} are determined as follows:

### B_{cred}=E(H(x), H(S)P)

In the above equation, x is a secret known only to Bob and Carol (such as Bob's account number), S is the bill of sale, and P is the agreed upon price associated with the bill of sale S. In some embodiments, Bob constructs his credentials B_{cred} from plaintext versions of the bill of sale S and/or the associated price P rather than as a hash. Using a hash, however, provides an abstraction of the details of the transaction. It should be understood that additional formulas or mechanisms can be used to determine credentials.

Since Bob and Carol know x (and the hash function if applicable), Bob and Carol can decrypt the credentials B_{cred} and can obtain the secure information regarding Bob's account. Trent, however, cannot obtain the secure information regarding Bob's account or, in some embodiment, the details of the transaction, such as the price.

Bob can generates credentials B_{cred} for each transaction, and Carol (who knows Bob's account number x and can generate H(x)) decrypts the credentials B_{cred} in order to obtain the bill of sale S and the corresponding price P. In some embodiments, if Carol manages multiple accounts for Bob each having account numbers xᵢ, x₂, . . . , xₙ, Carol generates a hash for each account number. If one of the hashes can decrypt the credentials B_{cred} generated by Bob, Carol knows which account to draw funds from. Bob can also append an account identifier to the credentials B_{cred} to identify a particular account.

In some embodiments, creating a hash of an account can create hash collisions where H(xᵢ)=H(xⱼ) and xᵢ does not equal xⱼ. Hash collisions can be detected at account creation and a colliding account number can be regenerated in order to prevent a hash collision.

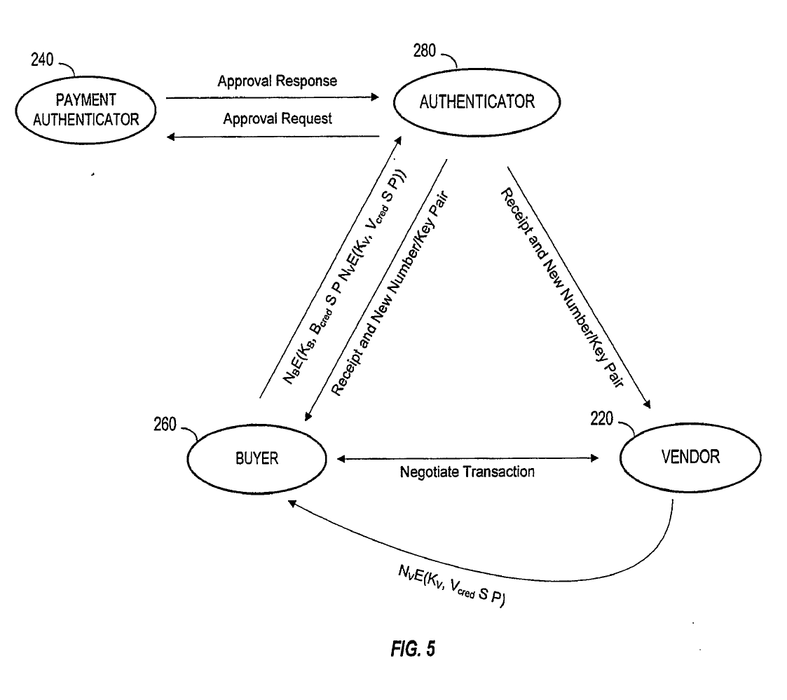

As shown in FIG. 5, to begin the purchase process, Vera sends Bob vendor transaction data. In some embodiments, the vendor transaction data includes the bill of sale S and/or the corresponding price P for the bill of sale S. In some embodiments, the vendor transaction data includes plaintext versions of the bill of sale S and/or the corresponding P. In other embodiments, the vendor transaction data includes a hash of the bill of sale (e.g., H(S)) and/or a hash of the price (e.g., H(P)). The vendor transaction data can also include credentials of Vera (e.g., V_{cred}). Vera's credentials V_{cred} can be a secret known or recognizable only to Vera, Carol, and Trent. In some embodiments, as described above, Vera's credentials V_{cred} are constructed from a secret known only to Vera and Carol, such as an account number of Vera assigned by Carol. In other embodiments, Trent assigns the credentials V_{cred} to Vera. Carol and/or Trent can use Vera's credentials V_{cred} to verify that the vendor transaction data was generated by Vera. The vendor transaction data can also include an identifier of a buyer (e.g., B_{id}) and/or an identifier of a payment authenticator (e.g., C_{id}) associated with the transaction. Vera “signs” all or part of the vendor transaction data by encrypting the data with her secret key K_{V} and appending her secret number N_{V} to the result. Vera sends the signed vendor transaction data to Bob.
V→B: N_{V} E(K_{V},H(S)P)

In one variant, as shown below, Vera also sends all or a portion of the vendor transaction data to Bob in plaintext. For example, Vera can send Bob the bill of sale S and/or the corresponding price P as plaintext. Bob can use the plaintext vendor transaction data to generate buyer transaction data.
V→B: S N_{V} E(K_{V},H(S)P)

Upon receiving the vendor transaction data from Vera, Bob generates buyer transaction data. The buyer transaction data can include the bill of sale S and the corresponding price P, which, when Bob acts correctly and honestly, are identical or equal to the bill of sale S and price P provided by Vera. In some embodiments, Bob generates the bill of sale S and the price P from a plaintext bill of sale and price provided by Vera. Bob can include the bill of sale S and/or the price P in the buyer transaction data as plaintext or as a hash (e.g., H(S) and/or H(P)).

Bob also includes his credentials B_{cred} in the buyer transaction data and, in some embodiments, identities of the participants of the transaction beside himself (e.g., V_{id} and C_{id}) in the buyer transaction data. Bob signs all or part of the buyer transaction data by encrypting the data with his secret key K_{B} and appending his secret number N_{B} to the result. Bob concatenates the signed buyer transaction data to Vera's signed vendor transaction data and sends the concatenated message to Trent.
B→T: N_{B} E(K_{B},H(S)P) B_{cred}V_{id}C_{id}N_{V} E(K_{V},H(S)P)

It should be understood that Bob can also initiate the purchase process. In some embodiments, Bob sends Vera signed buyer transaction data including the identities of Vera and Carol. Vera adds signed vendor transaction data to the signed buyer transaction data provided from Bob and forwards the concatenated message to Trent.

Trent unrolls the concatenated message (since he knows the secret keys of Bob and Vera identified by Bob and Vera's secret numbers N_{B} and Nᵥ, respectively, included in the message). In one implementation, Trent verifies that the buyer transaction data, or a portion thereof, (e.g., the bill of sale, the price, and/or the hashes of the bill of sale and/or price) transmitted from Bob matches the vendor transaction data, or a portion thereof, transmitted from Vera. If the data does not match, it is possible that Vera and Bob have not agreed on a common bill of sale and/or a related price, and Trent informs Bob and Vera of the discrepancy. Trent can also verify that the identities of the parties provided are compatible. For example, Trent can verify that the buyer identified by the vendor matches the identity of the buyer providing the buyer transaction data and that the vendor identified by the buyer matches the identity of the vendor providing the vendor transaction data.

If the data matches, Trent generates a payment request and transmits the payment request to Carol in order to request payment for the transaction between Bob and Vera. In some embodiments, the payment request includes the identities of the buyer and the vendor B_{id} and V_{id}, the credentials of the buyer and the vendor B_{cred} and V_{cred}, the bill of sale S, and the corresponding price P. The payment request can include additional or less information depending on the information needed by the payment authenticator 240 to verify the transaction and process payment from the buyer to the vendor. For example, Carol may not require the bill of sale or the identities of Vera and/or Bob in order to verify and process the payment request.

It should be noted that, in some embodiments, although Trent obtains Bob and Vera's credentials B_{cred} and V_{cred}, Trent cannot decode the credentials and, therefore, cannot obtain confidential information regarding Bob or Vera's account managed by Carol.

Trent encrypts the payment request with Carol's secret key K_{C} in order to prevent anyone but Carol from obtaining the data contained in the payment request. In some embodiments, Trent also appends Carol's secret number N_{C} to the encrypted payment request. Trent sends the resulting payment request to Carol.
T→C: N_{C}E(K_{C}, B_{id} V_{id} B_{cred} V_{cred} S P)

Carol receives the payment request and determines whether to approve payment for the bill of sale S. In some embodiments, Carol determines whether or not to approve payment by determining if Bob's account (identified by B_{cred}) contains enough funds to cover the price P associated with the bill of sale S. Carol can also verify that Vera's account (identified by V_{cred}) and Bob's account (identified by B_{cred}) are valid accounts. If Bob's account contains enough funds to cover the price P and Bob and Vera's accounts are valid, Carol transfers funds from Bob's account to Vera's account based on the price P. In some embodiments, Carol acts as an escrow and holds funds from Bob's account until Vera notifies Carol that goods and/or services included in the bill of sale S have been shipped and/or provided to Bob. Once the goods and/or services have been provided to Bob, Carol transfers the funds to Vera's account.

Upon approving the payment, Carol sends a payment response to Trent. The payment response can include all or part of the information included in the payment request. For example, the payment response can include the identities of the vendor and buyer, the bill of sale S, and the price P. In some embodiments, the payment response also includes a transaction number or reference number generated by Carol. To indicate that the transaction was approved and processed, the payment response also includes an approval indicator or message. Carol encrypts the payment response with her secret key K_{C} and, in some embodiments, appends her identifying number N_{C} to the encryption result. Carol sends the payment response to Trent.
C→T: N_{C}E(K_{C},B_{id} V_{id} S P “Approved”)

After receiving the payment response from Carol indicating approval of the payment request, Trent generates transaction receipts for one or more of the participants. These receipts can be used as evidence that the transaction was approved and completed. In one implementation, each receipt includes keys of two of the three participants (e.g., the keys of the participants to whom the receipt is not for), the bill of sale, and the price. Each receipt can also include credentials of the receipt recipient and/or the other participants. The receipt recipient can use the credentials to verify that the receipt was generated by Trent. It should be understood that a hash of the keys, the bill of sale S, the price P, and/or the credentials can be included in place of plaintext data in order to further increase the security and secrecy of the transaction. When hashes are provided, Trent obtains the hashes but cannot decipher the details of the transaction. Exemplary receipts for Vera, Bob, and Carol follow below:
T→V:E(K_{V},H(K_{B}K_{C}P)H(S)P)
T→B:E(K_{B},H(K_{V}K_{C}P)H(S)P)
T→C:E(K_{C},H(K_{B}K_{V}P)H(S)P)

Bob, Vera, and/or Carol can present Trent with the number they used in this transaction (e.g., N_{B}, N_{V}, or N_{C}), the price, and their receipt for transaction verification. For example, Trent can verify that the receipts are identical.

Trent also provides Vera, Bob, and Carol with new mutating IDs. Trent encrypts the new mutating ID for each party with the party's current secret key.
T→V:E(K_{C},N′_{V}K′_{V})
T→B:E(K_{B},N′_{B}K′_{B})
T→C:E(K_{C},N′_{C}K′_{C})

In some embodiments, Trent includes the new mutating IDs in the receipts for Bob, Carol, and Vera rather than sending them separately.

If Bob's account does not contain enough funds to cover the price P or if Bob or Vera's account is not valid, Carol rejects the payment request and does not transfer funds from Bob's account to Vera's account. To indicate the rejection of the payment request, Carol sends a payment response to Trent. As described above, the payment response can include all or part of the information included in the payment request. For example, the payment response can include the identities of the vendor and buyer, the bill of sale S, and the price P. In some embodiments, the payment response also includes a transaction number or reference number generated by Carol. The payment response also includes a declined indicator or message that indicates whether the transaction was rejected or declined. Carol encrypts the payment response with her secret key K_{C} and, in some embodiments, appends her identifying number N_{C} to the encryption result. Carol sends the payment response to Trent.
C→T: N_{C}E(K_{C},B_{id} V_{id} S P “Declined”)

After receiving the payment response from Carol indicating a declined payment request, Trent generates transaction receipts for Vera, Bob, and/or Carol as described above. The receipt indicates that the payment request was declined by Carol. Alternatively, Trent can send Vera and Bob a rejected or declined message that alerts Vera and Bob that the transaction was not processed. After receiving the payment response from Carol indicating a declined payment request, Trent can also provide Vera, Bob, and Carol with new mutating IDs as described above.

It should be understood that the steps and/or the order of the electronic commerce protocol as described above and illustrated in FIG. 5 can be modified. For example, Vera and Bob can request and receive a session key from Trent in order to securely negotiate the transaction. Alternatively or in addition, Vera and Carol and/or Bob and Carol can request and receive session keys from Trent so that Vera and/or Bob can directly provide transaction information, such as credentials, to Carol without passing the information through Trent. In some embodiments, Trent may also generate and provide Carol with receipts, message, and/or new mutating IDs that Carol can directly forward to Vera and/or Bob upon accepting or rejecting the payment request. Carol may also directly provide Vera and/or Bob with receipts and/or messages (e.g., as plaintext) upon accepting or rejecting a payment request. The roles of authenticator and payment authenticator can also be combined. For example, each payment authenticator can provide their own mutating IDs to their clients (individuals for whom they manage accounts for).

In addition, the above communication and commerce protocols (or portions thereof) can be combined. For example, electronic commerce transactions can be included in digital content purchases from a content provider or a service provider. Additionally, electronic commerce transactions can be watermarked to guarantee uniqueness in transaction data and corresponding receipts. Furthermore, the commerce protocol described above and illustrated in FIG. 5 can use separate encryption protocols, as described above, and encrypt discoverable data and undiscoverable data with separate, unrelated keys in order to decrease the effectiveness of brute force attacks on messages passed between Vera, Bob, Trent, and Carol. Additional combinations and configurations are also possible.

### Point-Of-Sale Transactions

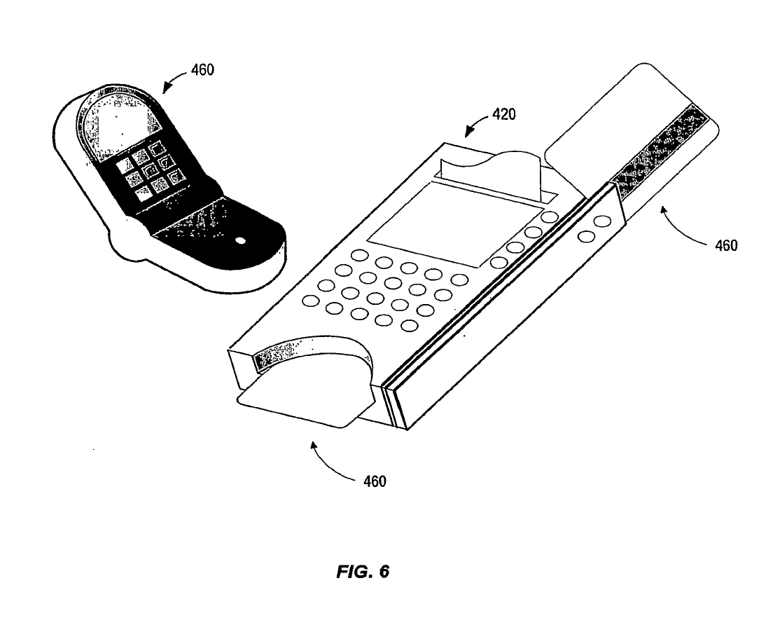

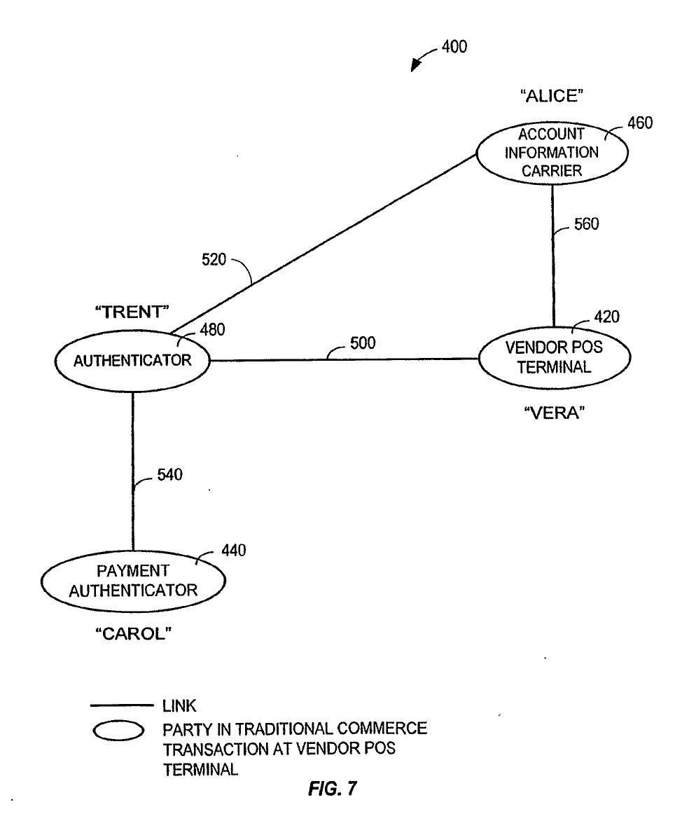

In addition to using mutating IDs in electronic commerce, mutating IDs can also be used in point-of-sale (“POS”) transactions where a buyer initiates a transaction at the physical location of a POS terminal of a vendor. FIGS. 6 and 7 illustrates an exemplary system 400 configured to perform transactions at a POS terminal of a vendor.

In the embodiment shown in FIG. 7, the system 400 includes four participants or entities: a vendor POS terminal 420; a payment authenticator 440, such as a credit card company, a financial institution, or the like; an account information carrier (“AIC”) device 460; and an authenticator 480. FIG. 6 illustrates the POS terminal in the form of a magnetic and smart card reader (such as the ones available from Verifone, Inc.) and an AIC device 460 in the form of a cellular phone, a smart card, or a credit card. Although, only one vendor POS terminal 420, payment authenticator 440, and AIC device 460 are shown, in most implementations numerous vendor POS terminals, payment authenticators, and AIC devices will be involved. Further, there could be multiple authenticators 480, although only one is required. In practice, it is likely that the following relationship will exist: number of authenticators<number of payment authenticators<number of vendor POS terminals<number of AIC devices, but again there is no limit on the number of participants or any requirement of a particular relationship between the numbers of the various types of participants.

In some embodiments, the vendor POS terminal 420, the payment authenticator 440, and the AIC device 460 are connected to the authenticator 480 via links 500, 520, and 540. The links 500, 520, and 540 can be two-way links and may be constructed from all or part of the networks mentioned above. As shown in FIG. 7, the vendor POS terminal 420 and the AIC device 460 are also connected via a link 560. The link 560 can include a radio frequency link, an infrared link, a wireless network link, a direct dock or wired link, or a cell phone link. In one embodiment, a cell phone may be configured to have the same physical connecter or plug used in smart cards (perhaps in the form of a flip out extension) so that an existing reader, such as the one shown in FIG. 6 can be used to obtain information from or otherwise communicate with the cell phone.

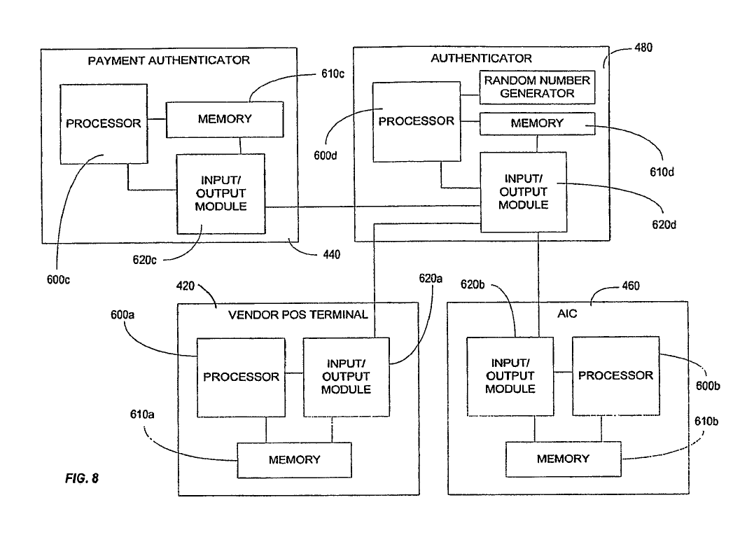

FIG. 8 schematically illustrates the vendor POS terminal 420, the AIC device 460, the payment authenticator 440, and the authenticator 480 included in the system 400 according to one embodiment of the invention. As shown in FIG. 8, each apparatus includes a processor 600 (e.g., 600a, 600b, 600c, and 600d), a memory module 610 (e.g., 610a, 610b, 610c, and 610d), and an input/output module 620 (e.g., 620a, 620b, 620c, and 620d). It should be understood that the components shown in FIG. 8 are exemplary and can be combined and distributed in various arrangements and configurations. For example, a memory module 610 can be included in a processor 600 and/or an input/output module 620 in place of or in addition to being included as a separate component. The input/output modules 610 can also be located in a device external to the apparatus housing the corresponding processor 600.

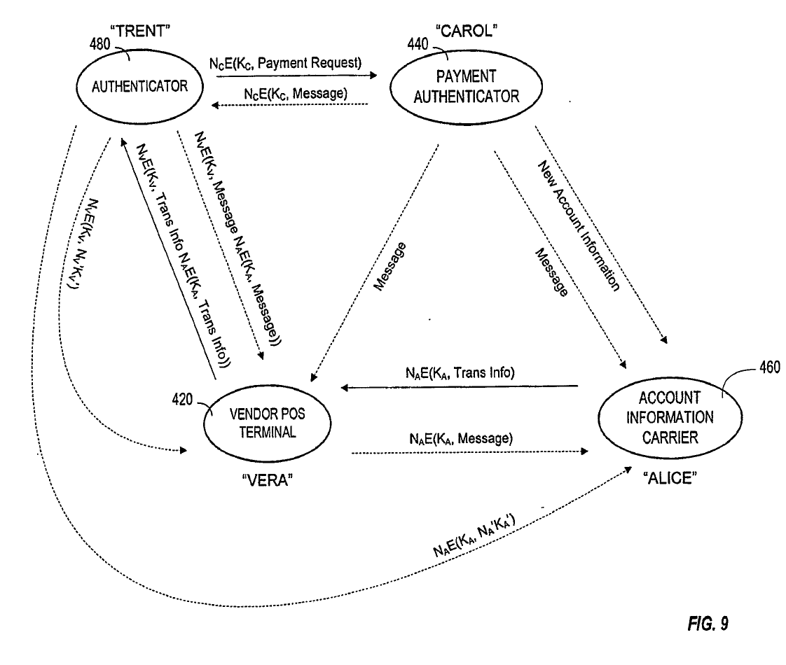

The processors 600 can include one or more processors or similar circuitry for performing a transaction at a vendor POS terminal using mutating IDs. In one embodiment, the memory modules 610 store instructions and data retrieved and executed by the processor 600 for performing a transaction at a vendor POS terminal using mutating IDs, as described below with respect to FIG. 9. The memory modules 610 can also store mutating IDs used to conduct a transaction. In particular, the memory module 610a, 610b, and 610c included in the vendor POS terminal 420, the payment authenticator 440, and AIC device 460, respectively, can be configured to store one or more mutating IDs assigned to each apparatus by the authenticator 480. Similarly, the memory module 610d included in the authenticator 480 can store the mutating IDs previously and currently assigned to each apparatus. In some embodiments, the memory module 610d can also store future mutating IDs awaiting assignment to a particular apparatus.

The functions performed by each processor 600, and consequently the instructions and data stored in the memory module 610 of each apparatus, can be configured based on the role a particular apparatus plays in performing a transaction. The memory modules 610 can also store data received or transmitted by a particular apparatus via its input/output module 620.

As shown in FIG. 8, each apparatus includes an input/output module 620 that interfaces with at least one communication link. It should be understood that although each apparatus is shown connected to every other apparatus by a single, direct connection, each apparatus can be connected to another apparatus via one or more wired or wireless connections over one or more networks or communication systems, as described above. Each input/output module 620 can also interface with additional apparatuses over the same or additional communication links.

As directed by the processor 600, each input/output module 620 can output data to another apparatus. Similarly, each input/output module 620 can receive data from another apparatus and forward the data to the associated processor 600 and/or memory module 610. As noted above, the input/output module 620 of a particular apparatus can be located in an apparatus external to the apparatus housing the processor 600 and/or the memory module 610.

As shown in FIG. 8 and as described above with to FIG. 1, the authenticator 480 also includes a random number generator 630. The authenticator 480 can use the random number generator 630 to generate random numbers used in the protocol implemented or followed by the system 400 for conducting a transaction at a vendor POS terminal using mutating IDs. As noted above, the random number generator 630 can produce numbers that are truly random (i.e., numbers that are as random as is possible with the particular technology used to implement the invention).

To complete a transaction at the vendor POS terminal 420, a buyer communicates with the vendor POS terminal 420 via the AIC device 460. The AIC device 460 can store account information for the buyer, such as an account number, a payment authenticator associated with the account number (e.g., VISA, MasterCard, etc.), an expiration date of the account, etc. The AIC device 460 can include a credit card, a cell phone, a smart card, a PDA, or the like, and the vendor POS terminal 420 can obtain the account information from the AIC device 460 via a credit card reader, keypad, keyboard, smart card reader, radio frequency receiver, wireless Internet receiver, an infrared receiver, a hard-wired dock, or the like, associated with the vendor POS terminal 420. In some embodiments, the AIC device 460 includes a static AIC device, such as a credit card, that cannot be reprogrammed with new account information. In other embodiments, the AIC device 460 includes a reprogrammable AIC device, such as a cell phone, a smart card, or other device with reprogrammable memory that can be reprogrammed with new account information. For purposes the following embodiments, the AIC device 460 included in the transaction includes a reprogrammable AIC device. It should be understood that the AIC device 460 can store additional data used for accessing accounts, buildings, vehicles, rooms, services, products, contacting individuals (e.g., phone numbers and/or email addresses), etc.

In some embodiments, the AIC device 460 can store account information provided or assigned by the payment authenticator 440. The payment authenticator 440 is an entity, such as a credit card company or a financial institution, which manages one or more accounts of a buyer that can be used to finance transactions (in terms of money or other payment forms or mechanisms). It is assumed that the payment authenticator 440 agrees to finance a transaction from an account upon receiving a valid payment request, and, therefore, account identifiers are kept confidential so that only authorized entities can generate valid payment requests. Thus, in some embodiments of the invention, the system 400 is configured such that the AIC device 460 and the payment authenticator 440 agree on a secret account identifier for an account of a buyer. For example, as described above with respect to the electronic commerce example, the AIC device 460 and the payment authenticator 440 can agree on a hash function for generating credentials to be provided to the vendor POS terminal 420. In other embodiments, the payment authenticator 440 can generate one or more one-time-use account numbers that can be transmitted to and/or programmed into (e.g., via a wireless Internet link, a cellular phone link, a radio frequency link, an infrared link, a new memory module, a direct wired reprogramming dock, etc.) the AIC device 460. Each one-time-use account number can be used once (provided to one vendor POS terminal 420 for one transaction) by the AIC device 460. Using one-time-use account numbers increases the security of account information since even if the one-time-use account number is obtained by an eavesdropper, the eavesdropper cannot use the one-time-use account number to conduct an illegal transaction because the one-time-use account number has already been used and cannot be used again. Alternatively, the AIC device 460 can store account information that includes a single account number for each account associated with the AIC device 460, such as the account number traditionally visually displayed on a card (e.g., a credit or debit card).

In addition, the AIC device 460 and the vendor POS terminal 420 each store a mutating ID assigned by the authenticator 480 that is known only to the authenticator 480 and the holder of the mutating ID. The AIC device 460 and the vendor POS terminal 420 use the mutating IDs to encrypt information (e.g., account information) before sending information to each other and/or to the authenticator 480. Since only the authenticator 480 knows the mutating IDs, the vendor POS terminal 420 cannot obtain information provided from the AIC device 460 that is encrypted or packaged with the mutating ID assigned to the AIC device 460, and the AIC device 460 cannot obtain information provided from the vendor POS terminal 420 that is encrypted or packaged with the mutating ID associated with the vendor POS terminal 420. In addition, since the authenticator 480 knows the mutating IDs assigned to the AIC device 460 and the vendor POS terminal 420, the authenticator 480 can decrypt the encrypted information received from both the AIC device 460 and the vendor POS terminal and can verify the information provided by each entity before allowing a transaction to continue.

In some embodiments, to complete a transaction, the vendor POS terminal 420 submits vendor information to the AIC device 460, and the AIC device 460 submits buyer information and the vendor information received from the vendor POS terminal 420 to the authenticator 480. In other embodiments, the vendor POS terminal 420 obtains buyer information from the AIC device 460, and the vendor POS terminal 420 submits the buyer information received from the AIC device 460 and vendor information to the authenticator 480. In still other embodiments, the vendor POS terminal 420 and the AIC device 460 separately submit information to the authenticator 480 and/or the payment authenticator 440.

In some embodiments, before sending information to the vendor POS terminal 420 and/or the authenticator 480, the AIC device 460 requires that the buyer enter authentication information, such as a personal identification number (“PIN”) or biometric information. The AIC device 460 uses the authentication information to ensure that the buyer associated with the account information stored on the AIC device 460 is using the AIC device 460 and not an imposter. The AIC device 460 can store authentication information of the buyer and can compare authentication information provided by a user of the AIC device 460 during a transaction to the stored authentication information. If the provided authentication information matches the stored authentication information, the AIC device 460 sends the encrypted account information to the vendor POS terminal 420 and/or the authenticator 480. If the authentication information does not match, the AIC device 460 rejects the transaction and does not send account information to the vendor POS terminal 420 and/or the authenticator 480. The user can enter authentication information via one or more selection or input mechanisms of the AIC device 460 and/or can enter authentication information via one or more selection or input mechanisms of the vendor POS terminal 420.

Once the authenticator 480 receives information from the vendor POS terminal 420 and the AIC device 460, the authenticator 480 generates a payment request for the payment authenticator 440. As described above with respect to the electronic commerce example, the payment request can include account information and/or transaction information received from AIC device 460 and the vendor POS terminal 420. In some embodiments, the authenticator 480 also assigns the payment authenticator 440 a mutating ID, and the authenticator 480 encrypts the payment request with the mutating ID assigned to payment authenticator 440.

The payment authenticator 440 verifies the payment request and can either accept or decline the request. The payment authenticator 440 sends its response to the vendor POS terminal 420 and/or the AIC device 460 either directly or indirectly through the authenticator 480.

As described in more detail below, in addition to forwarding a payment request to the payment authenticator 440, the authenticator 480 can also provides a new mutating ID to each entity. The authenticator 480 keeps track of assigned mutating IDs using a database or similar mechanism.

In some embodiments, the functionality of the authenticator 480 and the payment authenticator 440 can be combined and provided by a single entity, and, therefore, the authenticator 480 can directly decline or accept payment for a transaction without transmitting a separate payment request to a payment authenticator.

One example of a protocol for completing a transaction involving the system 400 illustrated in FIG. 7 will now be described. In this example, Alice (e.g., A) represents the AIC device 460 and manages information regarding one or more accounts (e.g., credit accounts, debits accounts, loyalty accounts, stored value accounts, etc.) of a buyer. Vera (e.g., V) represents a vendor POS terminal 420. Trent (e.g., T) represents the authenticator 480, i.e., a trusted arbiter of the sale. Carol (e.g., C) represents the payment authenticator 440, such as a credit card company or other account provider that has access to an account associated with the account information stored on the AIC device 460. The above table, Table 1, is a list of other symbols used to explain embodiments of the proposed protocol.

For this example, assume that Alice would like to communicate a credit card account number securely to Vera in a retail purchase transaction. In addition, assume that Alice has previously received account information Account_{A} from Carol that represents a credit card account number on file with Carol and has previously received a secret key K_{A} and an identifying number N_{A} (i.e., a mutating ID) from Trent. Furthermore, assume Trent has previously assigned Carol a secret key K_{C} and an identifying number N_{C} and has previously assigned Vera a secret key K_{V} and an identifying number N_{V}. In some embodiments, Trent also assigns Alice, Vera, and/or Carol credentials (e.g., A_{cred, V}_{cred}, C_{cred}, respectively) that each entity can include in messages. Trent can use the credentials to verify that messages were truly constructed by Alice, Vera, and/or Carol.

To initiate a transaction, Alice encrypts transaction information (e.g., the account information Account_{A} and a price P) with her secret key K_{A}. In some embodiments, Alice can also encrypt an identifier of Carol (e.g., C_{id}) and/or her credentials A_{cred} with her secret key K_{A}. Alice appends her identifying number N_{A} to the encryption result and sends the message to Vera.
A→V: N_{A} E(K_{A}, Account_{A} P C_{id})

As noted above, the AIC device 460 can store account information for a number of accounts associated with the buyer. In one implementation, the AIC device 460 displays available account information or identifiers of available account information (e.g., a description set by the buyer) to the buyer on a display of the AIC device 460, and the buyer selects particular account information for a current transaction using one or more selection mechanisms (e.g., a keypad, a touchscreen, etc.) on the AIC device 460. The AIC device 460 sends the selected account information to the vendor POS terminal 420. Alternatively, the AIC device 460 can transmit all available account information or identifiers of all available account information managed by the AIC device 460 to the vendor POS terminal 420, and the vendor POS terminal 420 can display available account information to the buyer. The buyer can then select particular account information using one or more selection mechanisms on the vendor POS terminal 420, such as a keypad, touchscreen, etc. For example, the buyer can select to use a MasterCard credit card account rather than a Visa credit card account as a payment source for a current transaction.

As noted above, in some embodiments, the AIC device 460 can require the buyer to input authentication information (e.g., a PIN, a password, a fingerprint, a retinal scan, etc.) before the AIC device 460 transmits transaction information (e.g., account information) to the vendor POS terminal 420. The buyer can enter the authentication information using one or more selection or input mechanisms of the AIC device 460. In other embodiments, the buyer can use one or more selection or input mechanisms of the vendor POS terminal 420 to provide authentication information. If the buyer uses the vendor POS terminal 420 to provide authentication information, the vendor POS terminal 420 can verify the authentication information, forward the authentication information to a third-party for verification, and/or forward the entered authentication information to the AIC device 460 for verification.

In one implementation, the buyer enters the price P of the goods and services involved in the transaction using one or more selection mechanisms of the AIC device 460 and/or the vendor POS terminal 420, such as a keypad or a touchscreen. Alternatively, the vendor POS terminal 420 transmits the price P (e.g., as plaintext) to the AIC device 460 before Alice initiates the processing of the transaction. The AIC device 460 includes the price P in the encrypted transaction data so that Trent can verify that Alice and Vera have agreed on a common price.

In some embodiments, the transaction information can also include an identifier of Vera (e.g., V_{id}) or the vendor associated with the transaction. The buyer can enter the vendor identifier V_{id} using one or more selection mechanisms included in the AIC device 460, or the AIC device 460 can obtain the vendor identifier from the vendor POS terminal 420 or a third-party device or system. The AIC device 460 can include the vendor identifier in the encrypted transaction information so that Trent can verify the entities involved in a transaction and prevent a vendor from falsely initiating a transaction on behalf of a buyer.

Upon receiving the encrypted information from Alice, Vera concatenates transaction information, such as the price P of the transaction and her identifier or account identifier V_{id}, to the encrypted information provided from Alice and encrypts the result with her secret key K_{V}. Vera appends her identifying number N_{V} to the result of the encryption and sends the message to Trent.
V→T: N_{V}E(K_{V}, P V_{id} N_{A}(K_{A}, Account_{A} P C_{id})

In some embodiments, Vera can also include an identifier of Alice (e.g., A_{id}) or the buyer associated with the transaction in the transaction information. The vendor POS terminal 420 can prompt the buyer to enter an identifier, and the buyer can enter an identifier using one or more selection mechanisms included in the AIC device 460 or the vendor POS terminal 420. The vendor POS terminal 420 can include the buyer identifier in the encrypted transaction information so that Trent can verify the entities involved in a transaction.

As described above, Vera may also initiate the transaction by encrypting the transaction information and sending the encrypted transaction information to Alice. Alice can concatenate her transaction information and the encrypted transaction information received from Vera, encrypt the result with her mutating ID, and send the resulting message to Trent. In other embodiments, Vera and Alice can separately send their information to Trent.

Trent identifies that the message has come from Vera and Alice because Trent knows that the number N_{V} is associated with Vera and that the number N_{A} is associated with Alice. Trent decrypts the message using K_{V} and K_{A}. In some embodiments, if Alice and/or Vera provided credentials, Trent verifies the credentials. If the credentials are not valid (e.g., they do not match the credentials currently assigned to Alice and/or Vera), Trent declines the transaction and sends a decline response to Vera and/or Alice. Trent can also verify that the transaction information, or a portion thereof, received from Vera and Alice match. For example, Trent can verify that the prices P receives from Vera and Alice match. If the prices do not match, Trent declines the transaction and sends a decline response to Vera and/or Alice. In addition, if Trent declines the transaction, Trent can provide Alice and Vera with new mutating IDs as described below.

If Trent verifies the information received from Alice and Vera, Trent generates a payment request for Carol. The payment request can include the account information Account_{A}, the transaction information (e.g., the price P of the relevant goods and services), and an identifier of Vera V_{id}. In some embodiments, the payment request includes additional or less information. For example, the payment request can also include an identifier of Alice and/or account information of Vera. The payment request can also include a new mutating ID for Carol (e.g., N_{C}′ and K_{C}′). Trent can encrypt the payment request with Carol's current secret key K_{C}. Trent can also append Carol's current identifying number N_{C} to the encryption result. Trent sends the resulting payment request to Carol.
T→C: N_{C}E(K_{C}, Account_{A} P V_{id})

In some embodiments, if payment for a particular transaction involves multiple payment sources (e.g., multiple accounts), Trent can generate and transmit a payment request to each payment authenticator that manages an account from which funds are to be drawn in order to complete the transaction.

Carol decrypts the payment request and uses the information included in the request to determine whether to accept or decline the payment request. If Carol accepts the payment request (e.g., the account identifier by Account_{A} includes adequate funds to cover the price P and the vendor identifier Y_{id} is a valid vendor identifier), Carol can generate an accept response. The accept response can include an accept message or identifier (e.g., ACCEPT) and a transaction identifier (e.g., Trans_{id}). The accept response can also include transaction information, such as the price P and the vendor identifier V_{id}.

Carol encrypts the accept response with her secret key K_{C}, appends her identifying number N_{C}, and sends the result to Trent. In some embodiments, Carol also includes her credentials C_{cred} in the accept response.
C→T: N_{C}E(K_{C}, ACCEPT P V_{id} C_{cred})

Trent decrypts the encrypted accept response and verifies Carol's credentials C_{cred} (if provided). Next, Trent generates accept messages for Vera and Alice. For example, to create an accept message for Vera, Trent can encrypt the decrypted accept response from Carol (without Carol's credentials C_{cred}, if provided) with Vera's secret key K_{V} and can append Vera's identifying number N_{V} to the encryption result. In some embodiments, Trent can add information to the accept message before encrypting the message. For example, Trent can add a new mutating ID for Vera (e.g., N_{V}′ and K_{V}) to the accept message. Trent sends the accept message to Vera.
T→V: N_{V}E(K_{V}, ACCEPT P V_{id} N_{V}′ K_{V}′)

Trent also creates an accept message for Alice by encrypting the decrypted accept response from Carol (without Carol's credentials C_{cred}, if provided) with Alice's secret key K_{A} and appending Alice's identifying number N_{A} to the encryption result. Trent can also add additional information to the accept message, such as a new mutating ID for Alice (e.g., N_{A}′, K_{A}′). Trent sends the accept message to Alice.
T→A: N_{A} E(K_{A}, ACCEPT P V_{id}N_{A}′ K_{A}′)

Alternatively, rather than directly sending separate accept messages to Vera and Alice, Trent can send Vera an accept message that include an accept message for Alice, and Vera can forward the accept message to Alice.

If Carol declines the payment request (e.g., Account_{A} does not include adequate funds to cover the price P, the account identifier Account_{A} does not identify a valid account, or the vendor identifier V_{id} is not a valid vendor identifier), Carol generates a decline response. The decline response can include a decline message or identifier (e.g., DECLINE) and a transaction identifier (e.g., Trans_{id}). The decline response can also include the transaction information (e.g., the price P) and/or the vendor identifier V_{id}. Carol sends the decline response to Trent.
C→T: N_{C} E(K_{C}, DECLINE P V_{id} C_{cred})

As described above with respect to the accept response, Trent verifies the decline response and generates decline messages for Vera and Alice based on the decline response received from Carol.

After receiving an accept message or a decline response from Trent, Vera and/or Alice can generate a receipt and/or store information for the transaction. The receipt and/or information can include the transaction identifier Trans_{id} provided by Carol, which can be used to access or obtain transaction information from Carol.

As described above, the AIC device 460 can store one or more one-time-use account numbers for a particular account. Each one-time-use account number can be used only once (provided to one vendor POS terminal 420 for one transaction). If Alice used a one-time-use account number to conduct the transaction, after the transaction is complete (e.g., accepted or declined), Alice can request and/or obtain one or more new one-time-use account identifiers from Carol. For example, Alice can place a call to Carol to receive one or more new one-time-use account identifiers for future transactions. The new one-time-use account identifiers can be transmitted to and/or programmed into the AIC device 460 via one or more communication links, as described above.

The above protocol greatly reduces the possibility of account information being stolen or used illegally. For example, since Alice provides encrypted account information that only her and Trent can decrypt, Vera never has possession of the actual account information. In addition, a transaction cannot be replayed since the account information is encrypted with a mutating ID that can only be used for one transaction.

Furthermore, the above protocol can be extended to provide additional security features, such as mechanisms for allowing an AIC device 460 to receive a particular invalid mutating ID from the authenticator if the AIC device 460 is reported stolen or lost. Use of an AIC device 460 that was reported stolen or lost and, consequently, was assigned an invalid mutating ID, causes the invalid mutating ID to be employed, which alerts the authenticator 480 that the AIC device 460 is being used illegally. Account information stored in an AIC device 460 can also be remotely erased or invalidated (e.g., via a command issued by the authenticator, a payment authenticator 440, and/or a user of the AIC device 460) if an AIC device 460 is reported lost or stolen. For example, a buyer can transmit a request to the payment authenticator 440 (e.g., call in) to invalidate the account information stored in an AIC device 460 so that the AIC device 460 cannot be used illegally after the AIC device is lost or stolen.

It should be understood that the steps and/or order of the point-of-sale transaction protocol described above and illustrated in FIG. 8 can be modified. For example, Vera and Alice can request and receive a session key from Trent in order to securely negotiate the transaction. Alternatively or in addition, Vera and Carol and/or Alice and Carol can request and receive session keys from Trent so that Vera and/or Alice can directly provide transaction information, such as account information, to Carol without passing the information through Trent. In some embodiments, Trent may also generate and provide Carol with receipts, messages, and/or new mutating IDs that Carol can directly forward to Vera and/or Alice upon accepting or rejecting a payment request. Furthermore, Carol can directly send, accept, or decline messages to Vera and/or Alice as plaintext. The roles of authenticator 480 and the payment authenticator 460 can also be combined. For example, each payment authenticator 460 can provide mutating IDs to their clients (individuals for whom they manage accounts for).

Furthermore, it should also be understood that the communication and transaction protocols (or portions thereof) described above with respect to session keys, content use licenses, digital signatures, discoverable and undiscoverable data, and electronic transaction can be combined with the proposed point-of-sale transaction protocol. For example, point-of-sale transactions can be included in digital content purchases from a content provider or a service provider. Additionally, point-of-sale transactions can be watermarked to guarantee uniqueness in transaction data and corresponding receipts. Furthermore, the point-of-sale transaction can use separate encryption protocols, as described above, and encrypt discoverable data and undiscoverable data with separate, unrelated keys in order to decrease the effectiveness of brute force attacks on messages passed between Vera, Bob, Trent, and Carol. Other combinations and configurations are also possible.

Various features of embodiments of the invention are set forth in the following claims.

1-33. (canceled)

34. A method of managing a transaction between a first entity and a second entity at a point-of-sale terminal of the second entity by an authenticator, the method comprising:
providing a first mutating identifier to an account information carrier device associated with the first entity over at least one communication link;
providing a second mutating identifier to the point-of-sale terminal over at least one communication link;
receiving encrypted transaction information from at least one of the account information carrier device and the point-of-sale terminal over at least one communication link, the encrypted transaction information encrypted with at least one of the first mutating identifier and the second mutating identifier;
decrypting the encrypted transaction information with at least one of the first mutating identifier and the second mutating identifier to obtain decrypted transaction information;
generating a payment request based on the decrypted transaction information;
transmitting the payment request to a payment authenticator over at least one communication link; and
marking the first mutating identifier and the second mutating identifier as used.

35. The method of claim 34, wherein providing a first mutating identifier to an account information carrier device associated with the first entity over at least one communication link includes providing a first mutating identifier including a number and a key to an account information carrier device associated with the first entity over at least one communication link.

36. (canceled)

37. The method of claim 34, wherein providing a second mutating identifier to a point-of-sale terminal associated with the second entity over at least one communication link includes providing a second mutating identifier including a number and a key to a point-of-sale terminal associated with the second entity over at least one communication link.

38. (canceled)

39. The method of claim 34, wherein receiving encrypted transaction information from at least one of the account information carrier device and the point-of-sale terminal over at least one communication link includes receiving encrypted transaction information from the account information carrier device over at least one communication link, the encrypted transaction information including a first message encrypted with the first mutating identifier and a second message encrypted with the second mutating identifier.

40. (canceled)

41. The method of claim 34, wherein receiving encrypted transaction information from at least one of the account information carrier device and the point-of-sale terminal over at least one communication link includes receiving encrypted transaction information from the point-of-sale terminal over at least one communication link, the encrypted transaction information including a first message encrypted with the second mutating identifier and a second portion encrypted with the first mutating identifier.

42. The method of claim 41, wherein decrypting the encrypted transaction information with at least one of the first mutating identifier and the second mutating identifier to obtain decrypted transaction information includes decrypting the first message with the second mutating identifier and decrypting the second message with the first mutating identifier.

43. The method of claim 34, further comprising verifying the decrypted transaction information.

44. The method of claim 43, wherein generating a payment request based on the decrypted transaction information includes generating a payment request based on the decrypted transaction information if the decrypted transaction information is verified.

45. The method of claim 44, further comprising generating and transmitting a decline message to at least one of the account information carrier and the point-of-sale terminal if the decrypted transaction information is not verified.

46. The method of claim 34, further comprising providing a third mutating identifier to the payment authenticator over at least one communication link.

47. The method of claim 46, further comprising encrypting the payment request with the third mutating identifier.

48. The method of claim 34, further comprising receiving a payment response from the payment authenticator over at least one communication link, the payment response including at least one of a payment accepted message and a payment declined message.

49. The method of claim 48, further comprising generating and transmitting an accept message to at least one of the account information carrier device and the point-of-sale terminal over at least one communication link if the payment response includes a payment accepted message.

50. The method of claim 48, further comprising generating and transmitting a decline message to at least one of the account information carrier device and the point-of-sale terminal over at least one communication link if the payment response includes a payment declined message.

51. (canceled)

52. (canceled)

53. A system for managing a transaction between a first entity and a second entity at a point-of-sale terminal associated with the second entity, the system comprising:
an authenticator configured to assign a first mutating identifier to an account information carrier device associated with the first entity, to assign a second mutating identifier to the point-of-sale terminal, and to assign a third mutating identifier to a payment authenticator;
the account information carrier device configured to encrypt first transaction information with the first mutating identifier to create first encrypted transaction information and to transmit the first encrypted transaction information to the authenticator over at least one communication link; and
the point-of-sale terminal configured to encrypt second transaction information with the second mutating identifier to create second encrypted transaction information and to transmit the first encrypted transaction information to the authenticator over at least one communication link;
the authenticator configured to decrypt the first encrypted transaction information with the first mutating identifier to obtain the first transaction information, to decrypt the second encrypted transaction information with the second mutating identifier to obtain the second transaction information, to generate a payment request based on the first transaction information and the second transaction information, to encrypt the payment request with the third mutating identifier to create an encrypted payment request, to transmit the encrypted payment request to the payment authenticator over at least one communication, and to mark the first mutating identifier and the second mutating identifier as used.

54. An account information carrier device for use in performing a transaction between a first entity and a second entity a point-of-sale terminal associated with the second entity, the account information carrier comprising:
a memory module configured to store a first mutating identifier;
an input/output module configured to send encrypted transaction information to the point-of-sale terminal over at least one communication link and to receive the first mutating identifier from an authenticator over at least one communication link; and
a processor configured to encrypt transaction information with the first mutating identifier to create the encrypted transaction information.

55. A point-of-sale terminal for use in performing a transaction between a first entity and a second entity at a point-of-sale terminal, the point-of-sale terminal associated with the second entity, the point-of-sale terminal comprising:
a memory module configured to store a second mutating identifier;
an input/output module configured to receive encrypted first transaction information from an account information carrier device associated with the first entity over at least one communication link, to send the encrypted first transaction information and encrypted second transaction information to an authenticator over at least one communication link, and to receive the second mutating identifier from the authenticator over at least one communication link; and
a processor configured to encrypt transaction information with the second mutating identifier to create second encrypted transaction information.

56. An authenticator for managing a transaction between a first entity and a second entity at a point-of-sale terminal associated with the second entity, the authenticator comprising:
a memory module configured to store a first mutating identifier assigned to an account information carrier device associated with the first entity, to store a second mutating identifier assigned to the point-of-sale terminal, and to store a third mutating identifier assigned to a payment authenticator;
an input/output module configured to transmit the first mutating identifier to the account information carrier device over at least one communication link, to send the second mutating identifier to the point-of-sale terminal over at least one communication link, to send the third mutating identifier to the payment authenticator, and to receive encrypted first transaction information and encrypted second transaction information from the point-of-sale terminal over at least one communication link; and
a processor configured to decrypt the first encrypted transaction information with the first mutating identifier to obtain first transaction information, to decrypt the second encrypted transaction information with the second mutating identifier to obtain second transaction information, to generate a payment request based on the first transaction information and the second transaction information, to encrypt the payment request with the third mutating identifier to create an encrypted payment request, and to mark the first mutating identifier and the second mutating identifier as used,
the input/output module configured to transmit the encrypted payment request to the payment authenticator.
